(19) United States
(12) Patent Application Publication
(10) Pub. No.: US 2014/0182105 A1
(43) Pub. Date: Jul. 3, 2014

(54) SYSTEMS AND METHODS FOR FENCE GATE ASSEMBLY

(71) Applicant: Marston Lee Tuck, Acworth, GA (US)

(72) Inventor: Marston Lee Tuck, Acworth, GA (US)

(21) Appl. No.: 14/210,860

(22) Filed: Mar. 14, 2014

(51) Int. Cl. B27F 7/15; B23P 19/04; B30B 9/00; F16B 15/00

(52) U.S. Cl. CPC B27F 7/155; F16B 15/0023; B23P 19/04; B30B 9/00
USPC 29/407.1; 411/443; 227/153; 29/432

(57) ABSTRACT

Systems and methods are presented herein for assembling a fence gate on-site. The system may include a fence press and a nail plate. The fence press may be smaller and more portable than typical presses, and adapted to press the nail plate into a junction of a plurality of boards to create the fence gate. In one embodiment, the fence press presses the nail plate into three boards at once, causing a strong union at the plate location. The nail plate may contain protrusions that have a hook feature to prevent the nail plate from pulling out of the boards. In one embodiment, the hook feature may include a sub-protrusion on the protrusion. The fence press may include a pressing surface that is substantially the same shape as the nail plate, and may be adapted to hold the nail plate in place as the press operates.

### DESCRIPTION OF THE EMBODIMENTS

1. Field of the Embodiments

The embodiments relate generally to systems and methods for assembling fence gates, and more specifically, to pressing fence gates together at an on-site location.

2. Background

The most difficult part of assembling a fence in a residential or commercial setting tends to be assembling a fence gate. Because the gates swing open, they are inherently more complex and more difficult to build than the rest of the fence. For this reason, practitioners typically acquire a pre-assembled gate and take it to the site, where it is fastened to a post or otherwise incorporated into the fence.

But the fencing industry's use of pre-assembled gates poses problems. For example, hauling a gate to a construction site uses up valuable space in a vehicle, such as a pickup truck, in comparison to hauling non-assembled materials. In addition, a pre-assembled gate may not take into consideration factors such as the slope of the earth at a fence opening, imperfect dimensions of the fence opening, or other factors that may require fence gate customization.

Because of this, some fence companies attempt to build custom fence gates on-site. However, this is also problematic for a number of reasons. First, building a fence gate from scratch is a time consuming endeavor that can take up as much time as building the rest of the fence. Second, techniques used in building on-site fences typically result in failures. That is, the gates built on-site often are not strong enough to resist sagging and/or otherwise deteriorating, which results in return trips for maintenance and adjustments by the installer.

Therefore, a need exists for improved systems and methods for assembling fence gates at an on-site location.

### SUMMARY

Embodiments described herein include systems and methods for building a fence gate on-site. These systems and methods may include a new fence press and new nail plate for use with the fence press, and methods for using the same.

In one embodiment, the system includes a fence press that includes a press frame having a first side, a second side, a top, and a bottom, wherein the first and second sides are opposite from one another and substantially perpendicular to the top and bottom. The press body may be coupled to a first press plate and a slidably coupled to a second press plate, such that the first and second press plates may be pressured together in order for the press to operate.

The first press plate may include a first contact surface, the first press plate extending from the bottom of the press frame, the first press plate being stationary with respect to the press frame and positioned closer to the first side than the second side, wherein the first press plate is coupled to a first handle. Similarly, the second press plate may include a second contact surface that opposes the first contact surface, wherein the second press plate is slidably coupled to the press frame and slides towards the first press plate based on pressure in the press frame.

The press may operate through use of a nail plate that may be pressed into multiple fence gate boards simultaneously. The nail plate may be substantially the same shape as the second contact surface, wherein the nail plate includes a flat side and an opposite side with protrusions, wherein the flat side rests against the second press plate such that the opposite side faces the first contact surface.

Two or more of the protrusions may include a hook element. The hook element may allow for the protrusion to sink into wood, but provide resistance that helps prevent the protrusion from easily pulling back out of the wood.

The protrusions may be extruded in one embodiment, or may be punched from the nail plate in another embodiment. In one embodiment, the shape of the protrusion punched from the nail plate includes a hook element. In another embodiment, the protrusion is punched from the nail plate, and the hook element is punched from the protrusion, for example, via a single cut into the protrusion.

In one aspect, the fence press may press the nail plate into a junction of at least three pieces of wood, thereby coupling all three pieces together and providing stability to the fence gate.

It is to be understood that both the foregoing general description and the following detailed description are exemplary and explanatory only and are not restrictive of the embodiments, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1A is an exemplary illustration of a fence press, in accordance with an embodiment;

FIG. 1B is an alternative exemplary illustration of a fence press, in accordance with an embodiment;

FIG. 1C is an alternative exemplary illustration of a fence press, in accordance with an embodiment;

FIG. 2 is an exemplary illustration of a profile view of a fence press, in accordance with an embodiment;

FIG. 3 is an exemplary illustration of a nail plate, in accordance with an embodiment;

FIG. 4 is a further exemplary illustration of a nail plate, in accordance with an embodiment;

FIG. 5 is an exemplary close-up illustration of protrusions on a nail plate, in accordance with an embodiment;

FIG. 6A is an exemplary illustration of a fence gate built using nail plates and methods described herein, in accordance with an embodiment;

FIG. 6B is an exemplary illustration of a nail plate with regions to assist in construction, in accordance with an embodiment;

FIG. 7 is an exemplary illustration of a fence gate built on a slope and incorporating nail plates, in accordance with an embodiment;

FIG. 8 is an exemplary illustration of a fence press pressing a nail plate into three boards of a fence gate simultaneously, in accordance with an embodiment;

FIG. 9 is an exemplary flow chart with non-exhaustive listings of steps to build a fence gate using a fence press and a nail plate, in accordance with an embodiment; and

FIG. 10 is another exemplary flow chart with non-exhaustive listings of steps to build a fence gate using a fence press and a nail plate, in accordance with an embodiment.

### DESCRIPTION OF THE EMBODIMENTS

Reference will now be made in detail to the present exemplary embodiments, including examples illustrated in the accompanying drawings. Wherever possible, the same reference numbers will be used throughout the drawings to refer to the same or like parts.

In one embodiment, a system includes a fence press and a nail plate that may be pressed into multiple boards at once, reducing the chance of error in on-site fence gate construction and ultimately producing a stronger fence gate that lasts longer than typical on-site fence gates. The fence press may operate in conjunction with use of one or more nail plates. A nail plate may be positioned on one of the two press plates, such as by placing the nail plate on the boards that it will join, and then using the fence press to squeeze the nail plate fully into the boards. The nail plate may have protrusions that are forced into the wood by the fence press. In one embodiment, a subset of the protrusions are longer than the other protrusions, which may allow a person to press the nail plate partially into the wood by hand, and once the nail plate is in place, press it all the way into the wood using the fence press.

The fence press is provided may include a press body and first and second press plates. The fence press may be pneumatic (i.e., controlled by air pressure), causing the first and second pressing plates to press together. In one embodiment, the fence press is smaller than conventional air presses, allowing for portability to a job site. Unlike a prebuilt gate, which takes up large amounts of space in a truck, the fence gate materials can be taken to the site unassembled for assembly using the fence press.

This system and method of construction may allow for faster and stronger building of a fence gate. In particular, a worker may use the fence press with a single nail plate to join a plurality of boards together, such as a top piece, side piece, and diagonal support piece. It is also easier than current approaches, which require driving nails through one board and into another.

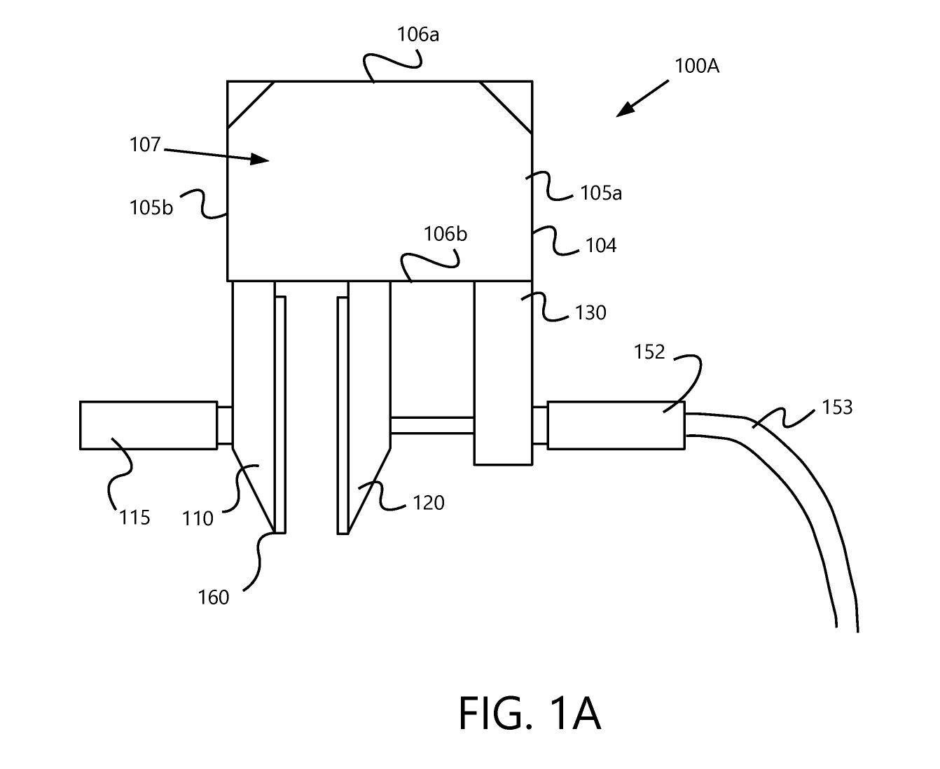

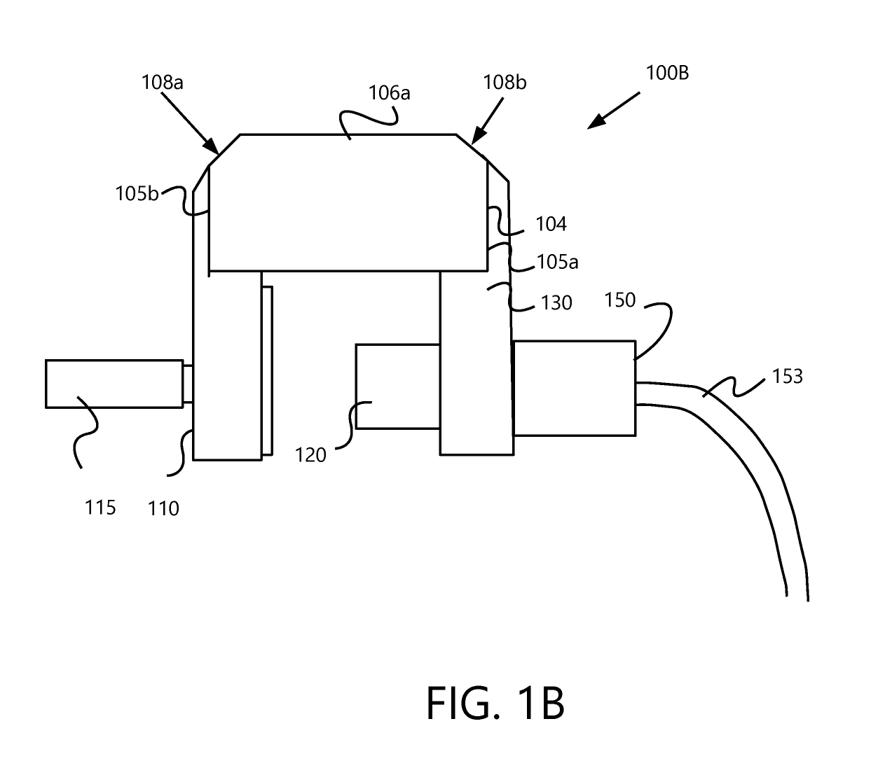

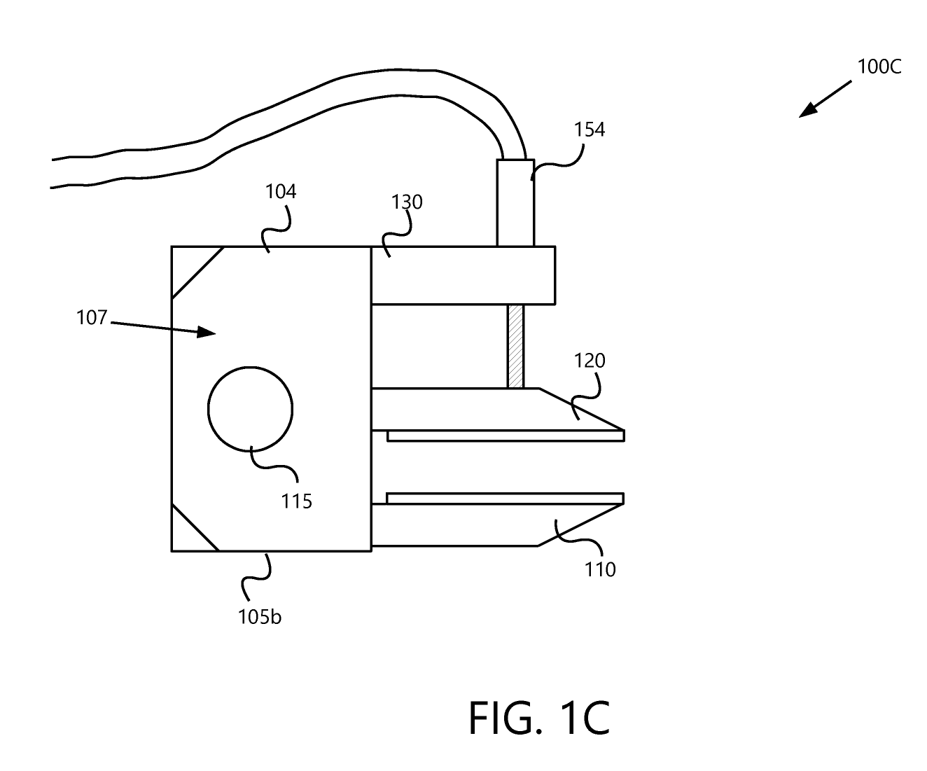

Turning to FIGS. 1A and 1B, two example fence presses 100A and 100B are illustrated in accordance with separate embodiments. Each includes a press body 104, and first and second press plates 110 and 120, respectively. The first press plate 110 may be fixed to the press body 104, such as by welding the two pieces together. The second press plate 120 may be slidably coupled to the press body 104. For example, as shown in FIGS. 1A and 1B, a support member 130 may be welded to the press body 104 (and for the purposes of this disclosure, is treated as part of the press body 104), and the second press plate 120 may be braced by the support member 130 in a manner that allows the second press plate 120 to slide towards the first press plate 110.

The press body 104 may include right and left sides 105a and 105b, respectively, and a top 106a and bottom 106b. It also may include a face 107. In one embodiment, for example as shown in FIG. 1A, the left side 105b may extend past the first press plate 110 and the right side 105a may extend past or align with the support member 130.

In another embodiment, for example as shown in FIG. 1B, the press body 104 may include beveled surfaces 108a and 108b at the upper left and upper right portions of the press body 104. This may help distribute side pressure from the first press plate 110 and support member 130 onto the press body 104, and reduce the chances of the support member 130 or support body 104 breaking the weld with the press body 104.

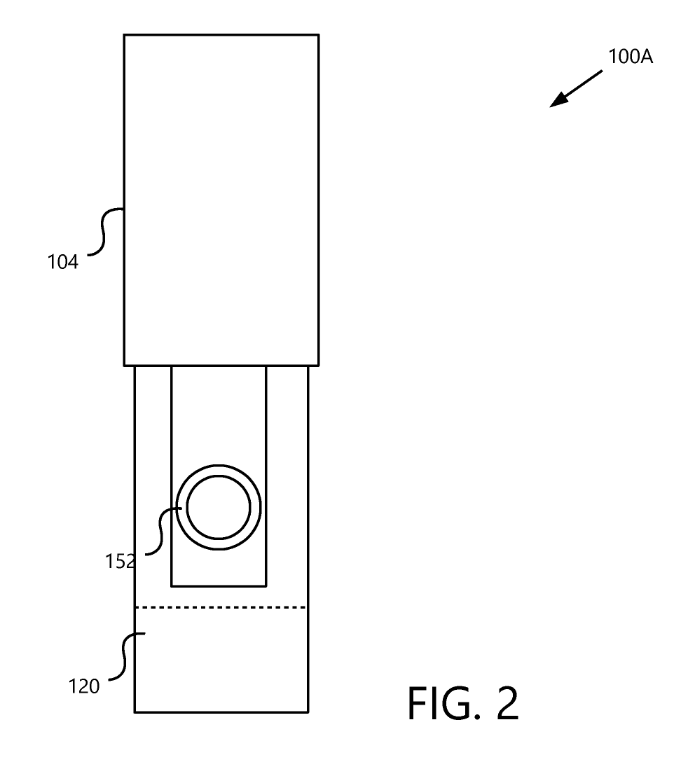

In the example of FIG. 1A, the second press plate 120 also extends to the press body 104 and moveably rests within a track built into the press plate 120 to guide the second press plate 120 toward the first press plate 110 with accuracy. This may also allow the second press plate 120 to be much larger than a pneumatic element 150 or 152 that pushes the press plate 120. However, as shown in FIG. 1B, in another embodiment the second press plate 120 does not make direct contact with the press body 104, and is instead coupled to the press body 104 only via the support member 130. A profile view of the exemplary fence press 100A is shown in FIG. 2.

In the example of FIG. 1A, the pneumatic element 152 is externally pressurized by attaching to a compressor (not pictured) via an air hose 153. The pneumatic element 152 also acts as a second handle opposite first handle 115. As air pressure increases, the pneumatic element pushes the second press plate towards the first plate. In the example of FIG. 1B, the pneumatic element 150 may be externally pressurized in a similar manner.

Alternatively, the pneumatic element 150 may include a pressurized cartridge that is inserted into an opening in the support member 130. The opening on the outside surface of the pressurized element may be large enough to accept the pressurized cartridge 150 and include a means of attaching the pressurized element to the support member 130. For example, the pneumatic element 150 may include a lip (not pictured) that catches an inner lip in the opening of the support member, such that the pneumatic element 150 may be inserted into the opening between the first press plate 110 and the support member 130, preventing the pneumatic element 150 from passing completely through the opening in the direction away from the first press plate 110.

In still a further embodiment, as illustrated in FIG. 1C, the fence press 100C utilizes a hydraulic ram 154, which for the purposes of this disclosure is considered one example of a pneumatic element. The ram 154 may cause the second press plate to move towards or away from the first press pate based on fluid (e.g., oil) that is pumped into and out of the ram 154. In this embodiment, the handle 115 may be mounted on the face 107 of the press body 104 such that the fence press 100C may be placed on the ground without interference from handle 115. For example, the first press plate 110 and the left side may rest along the ground. This can allow a user to place the fence press 100C on the ground, slide boards into the press plate 100C between the first and second press plates 110 and 120. It may be advantageous in some situations to lay out the boards that will comprise the fence gate on the ground. Then using the fence press 100C, the boards can be joined together while only slightly lifting them to place them above the first press plate 110.

A similar configuration as the one shown in FIG. 1C can also be utilized with respect to embodiments that include a different pneumatic element than the hydraulic ram 154.

The fence press 100A, 100B, and 100C may be sized for easy portability. For example, in one embodiment, the longest dimension of the fence press 100A is less than 28 inches. In another embodiment, the longest dimension is from the outer end of handle 115 to the outer end for pneumatic element 152. In another embodiment, the maximum opening between the first and second press plates 110 and 120 is six inches. In still another embodiment, the length between the outer edge 160 of the press plate 110 to the bottom 106b of the press body 104 is less than 6 inches.

The fence press 100A may be made out of steel, titanium, and/or any other metal material capable of holding up to forces required to drive nail plates into wood. In one embodiment, the fence press may apply 10 tons of force. In another embodiment, the fence press applies more than 4 tons and up to 20 tons of force. The fence press may be welded together in one embodiment such that the first press plate 110, the press body 104, and the support member 130 are all unified as a solid object.

The press plate shape may vary in different embodiments. In FIG. 1A, the first press plate 110 is shaped substantially the same as the second press plate 120. However, in FIG. 1B, the first press plate 110 is shaped differently than the second press plate 120. In one embodiment, each press plate 110 and 120 has contact surfaces (i.e., the surface that contacts wood or a nail plate) that are shaped differently to correspond to two differently-shaped nail plates. In the example of FIG. 2, the first press plate 110 may be substantially rectangular while the second press plate 120 is substantially oval or circular. In that example, a user may orient the fence press such that the first press plate 110 drives a rectangular nail plate into the boards of a fence gate, and then reverse the orientation to use the second press plate 120 to drive a circular or oval nail plate into the boards.

In one embodiment, a portion of the contact surface of one or both of the press plates 110 and 120 may have magnetic properties. For example, the press plate may contain a notch having a magnet embedded into it. This may allow the press plate 110 or 120 to magnetically attract and hold a metal nail plate while the boards are being placed within the fence press 100A.

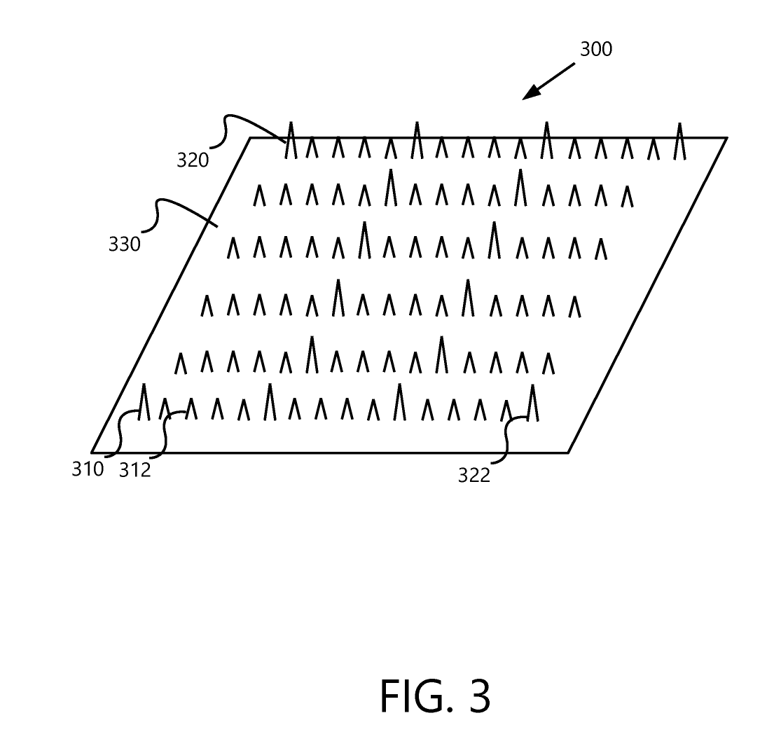

Turning to FIG. 3, an exemplary nail plate in accordance with an embodiment is presented. The nail plate may have a plurality of protrusions 310, 312 that may be organized in rows on a base plate 330, in one embodiment. The protrusions may all be one side of the base plate 330, whereas the opposite side may be substantially smooth. For example, the protrusions may be punched from the base plate 330, causing them to protrude outward from the side opposite the substantially smooth side.

The nail plate may have a width of less than 5 inches and a height of less than 8 inches in one embodiment. It may also be made out of any materials useable for construction hardware, and may be printed on a three-dimensional printer in one embodiment.

A first protrusion 310 may be longer than a second protrusion 312 within the plurality of protrusions in one embodiment. In another embodiment, the upper-left-most and lower-right-most protrusions may be longer than the adjacent protrusions in any direction. This may allow a user to position the nail plate on one or more boards by pressing the nail plate partially into the boards by hand. The limited number of longer protrusions may require less force to push into the wood than the complete set of protrusions, allowing the user to more easily press the nail plate up to the point where the next shorter set of protrusions makes contact with the wood. In one embodiment, three different lengths of protrusions are included in the plurality of protrusions.

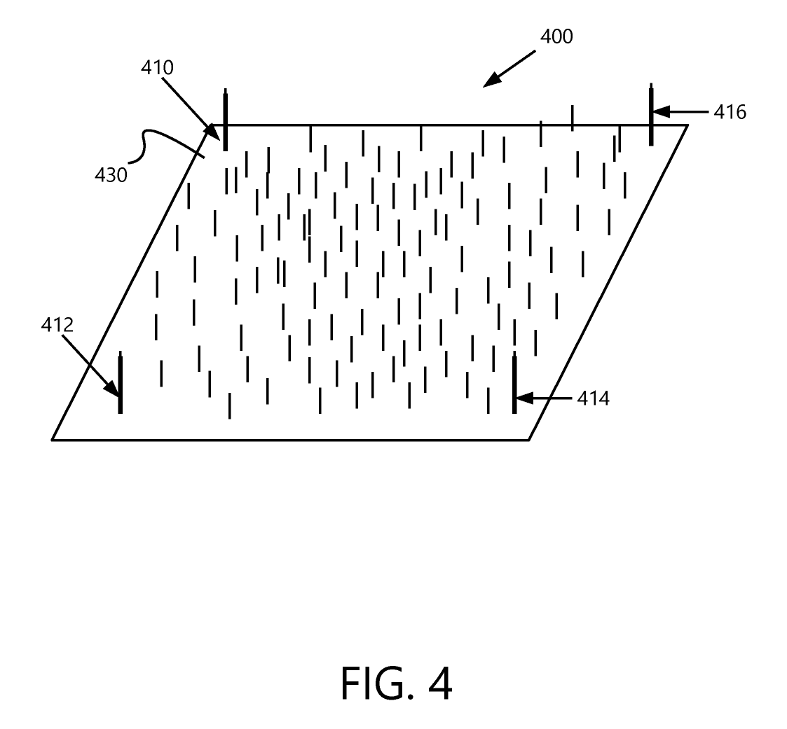

In the example of FIG. 4, the protrusions of nail plate 400 are not arranged in rows, and are two different lengths. In particular, the corner protrusions 410, 416, 412, and 414 are longer than all other protrusions, to allow a user to more easily position the nail plate 400 on a plurality of boards that will be joined together to form the fence gate.

Additionally, the protrusions may be extruded onto the base 430 in one embodiment. This may be done, for example, by created the nail plate with a three dimensional printer that prints the protrusions and the base plate 430, or prints the protrusions onto an existing base plate 430.

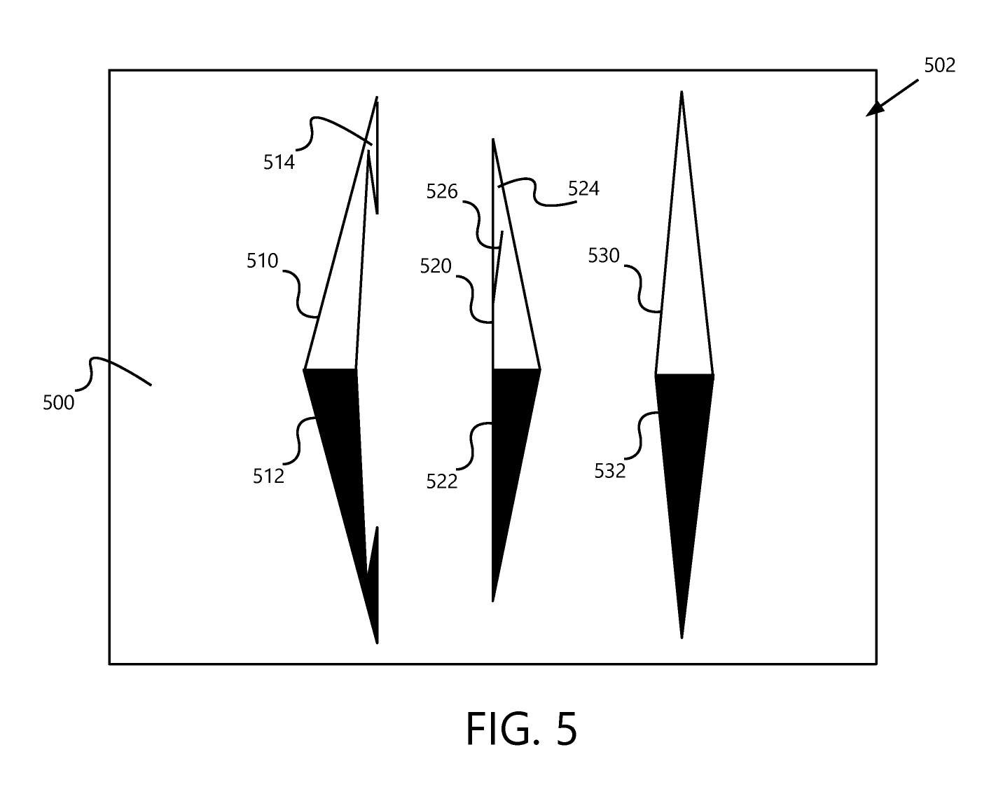

In another embodiment, as illustrated in FIG. 5, the protrusions 510, 520, 530 may be punched out from the base plate 500. A tool may be used in the manufacturing process to punch a hole in the shape of the protrusion, leaving the bottom side of the protrusion intact and bending the other metal outward to form the protrusion. For example, a first protrusion 510 may be punched from the base plate 500, leaving behind first hole 512. The same may be true for second protrusion 520, and second hole 522, as well as third protrusion 530 and third hole 532.

Continuing with FIG. 5, protrusion 510 includes a hook element 514. A hook element may help prevent a nail plate from coming loose from one or more boards after being pressed into the boards. Unlike a traditional nail plate, the hook element provides resistance to removal by providing and additional edge to catch the wood. In one embodiment, hook elements are present on a multiple protrusions around the periphery of the overall plurality of protrusions. For example, each corner protrusion may be slightly longer than the other adjacent protrusions and/or include a hook element.

Protrusion 510 may be punched from the base plate 500 in a shape that includes the hook element 514. Conversely, protrusion 520 also includes a hook element 524, but the hook element 524 itself is not punched from the shape of the hole 522 in the base plate 500. Instead, an additional cut 526 is made during the punching process, and the hook element is then flexed out from the protrusion 520, in effect acting as a sub-protrusion of the protrusion.

In addition to providing the above-described hook function, the sub-protrusion hook element 524 may also provide a lateral force that helps the nail plate remain in the wood, because the sub-protrusion may be bent slightly inward, resulting in a residual stress that causes the hook element 524 to laterally pressure the inside of the wood. This additional lateral residual stress may cause the sub-protrusion hook element 524 to grip the inside of the fence gate or other lumber even more effectively.

Additionally, as shown in FIG. 5, multiple types of hook elements 514 and 524 may be used in a single nail plate 502.

One example method of creating nail plate 502 may include using a mold block to punch the protrusions from the metal. The mold block may include top and bottom portions that are pressed together. In one embodiment, the protrusions are cut when the top portion presses into the metal. The top portion may contain multiple juts or escalations that cut into the metal and cause the protrusions to bend into contact with the bottom portion. The bottom portion may likewise contain a second plurality of juts and escalations for creating sub-protrusions. For example, the pressure against the second plurality of juts and escalations on the bottom portion may cause the sub-protrusions to be cut from the protrusions, and bend away to form the hook element.

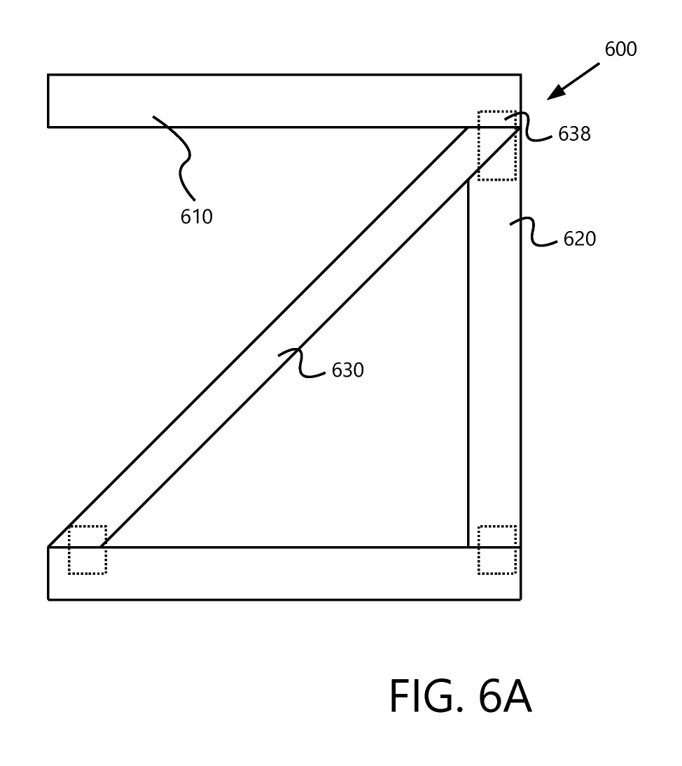

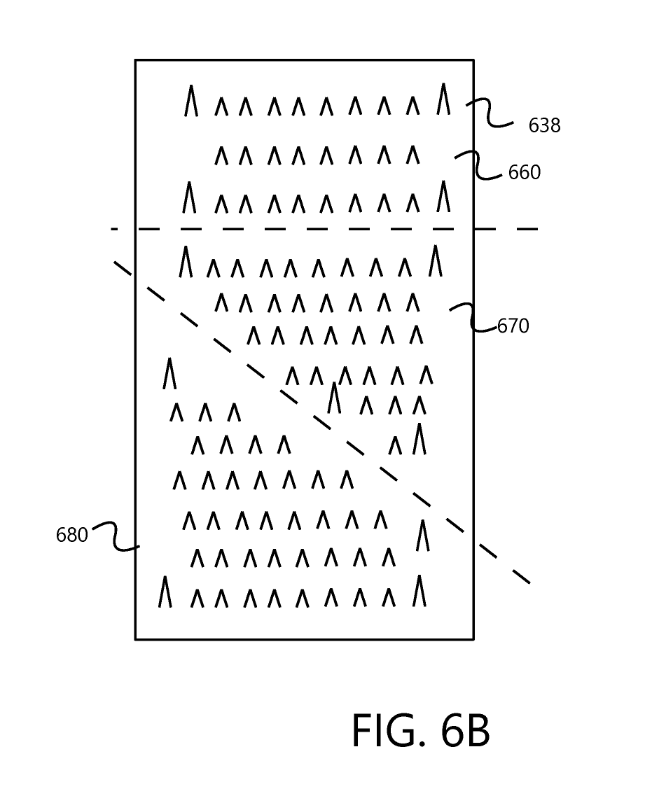

FIG. 6 presents an exemplary illustration of three boards 610, 620, and 630 used in a fence gate 600 that each may be joined together by a single nail plate 638. The nail plate 638 may span some portion of all three boards, and by using a gate press 100A, 100B, or 100C, may be pressed into all three boards simultaneously. This not only is faster than traditional gate building approaches, but it also may provide greater strength and stability. In one embodiment, a second plate press (not pictured) is placed on the opposite side of the junction of boards 610, 620, and 630, and both nail plates 638 may be pressed into the boards 610, 620, and 630 simultaneously by the first and second press plates of the fence press. In another embodiment, the simultaneously pressed nail plates may have different sizes and/or protrusion configurations.

Turning to FIG. 6B, example nail plate 638 may have three regions 660, 670, and 680 of protrusions that assist the user in determining how to align the boards 610, 620, and 630, and how to position the nail plate 638 at the junction of those boards. In particular, board 610 may correspond to the first region 660, board 620 may correspond to the second region 670, and board 630 may correspond to the third region 680. Each region may include relatively longer protrusions at the region corners, to both help define the regions and also allow the user to better manually position the press plate 638 prior to using the fence press 100A. Other region configurations are also possible for alternate applications.

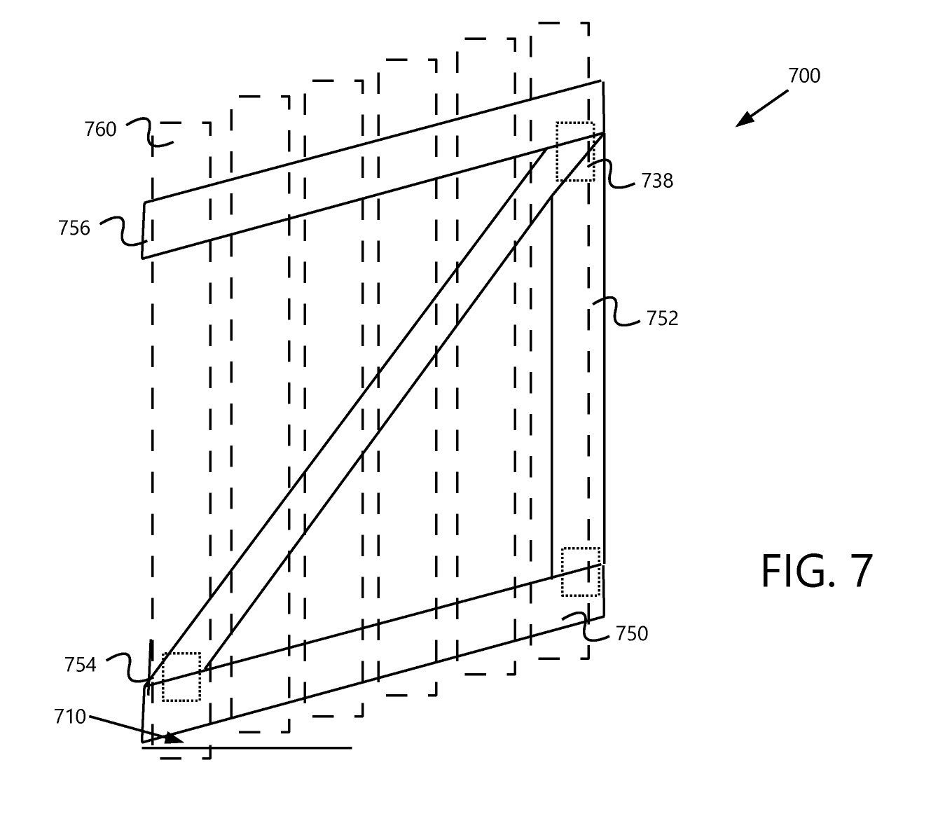

Turning to FIG. 7, an example illustration is presented of a fence gate 700 that can be built on a slope. The worker may determine a ground slope line to build the bottom of the fence gate to be parallel with, to ensure the fence gate can open and close without dragging the earth while still being low enough to the ground to keep pets and other animals from easily passing beneath the gate. By utilizing a fence press 100A and one or more nail plates 738, the angle 710 of the bottom 710 of the fence gate may be adjusted easily with respect to the ground. This may include adjusting the angle of diagonal board 754 and top board 756 while keeping side board 752 in a vertical position, and pressing the nail plate 738 into all three boards. Once the gate frame 700 is built, fence siding boards 760 may then be added through traditional means.

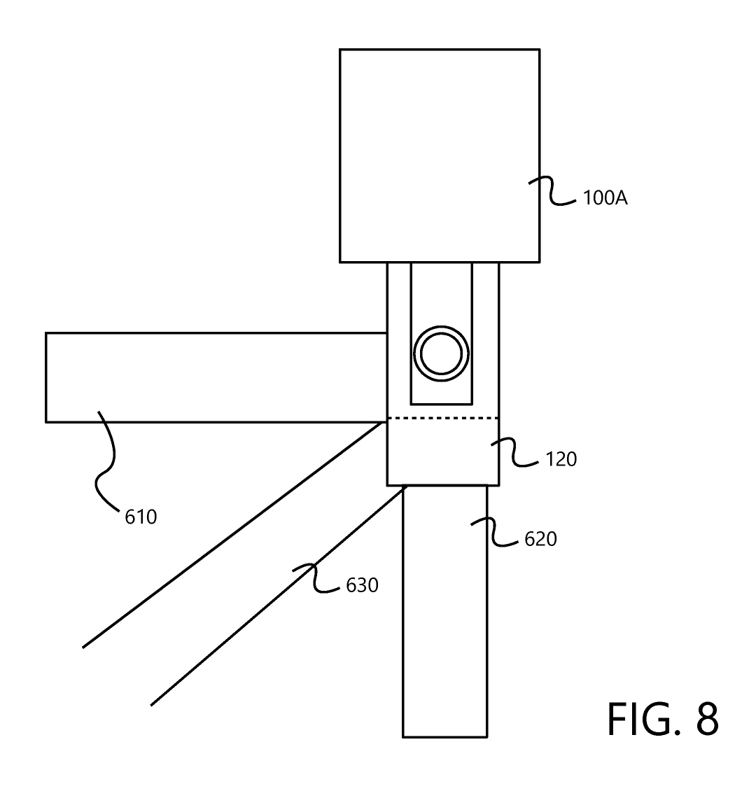

For example illustration purposes, FIG. 8 shows a fence press 100A pressing a top board 610, side board 620, and diagonal board 630 together. The nail plate is not visible because it is being pressed into all three boards by the first or second 120 press plate.

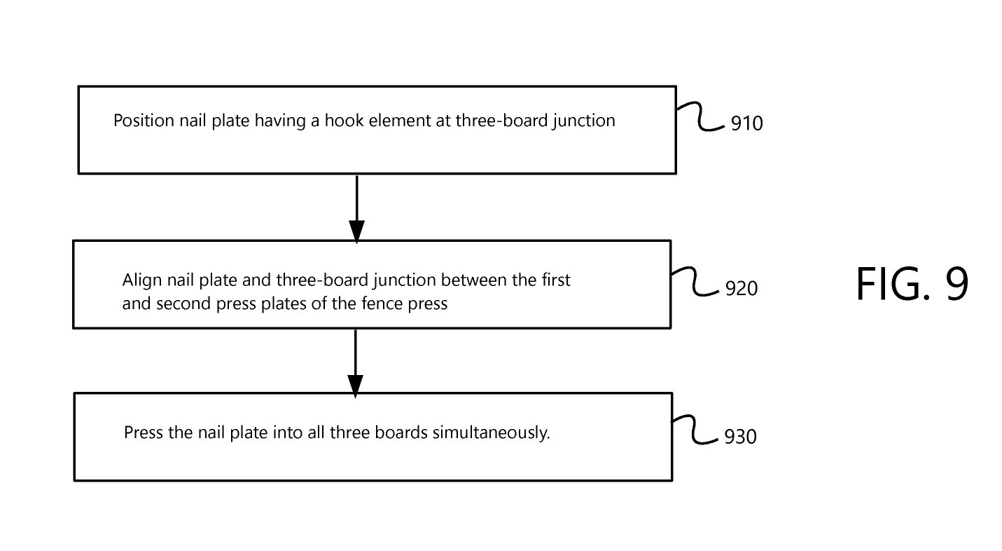

Turning now to FIG. 9, FIG. 9 shows example method steps for building a fence gate, in accordance with an embodiment. At step 910, a worker may position a nail plate having at least one hook element at a junction of three boards, such as discussed with respect to FIG. 6A. The positioning may include manually pushing the nail plate such that one or more protrusions partially sink into the wood of one or more of the boards being joined.

At step 920, the worker may align the nail plate and junction between the first and second press plate of the fence press, such as illustrated in FIG. 8. In one embodiment, the nail plate may be substantially the same shape and/or dimensions as the fence press to facilitate proper alignment. In another embodiment, the contact surface of one of the press plates may have a slight indention in the shape of the nail plate to assist with alignment.

At step 930, the worker may press the nail plate into all three boards simultaneously using the fence press. The fence press may include a pneumatic element that is actuated via a switch or trigger, by rotation, or by pressing on the pneumatic element, depending on the embodiment. Then, the pneumatic element may cause the second press plate to retract, leaving the nail plate in place. A hydraulic system may alternatively be used, for example, as referenced with regard to 1C.

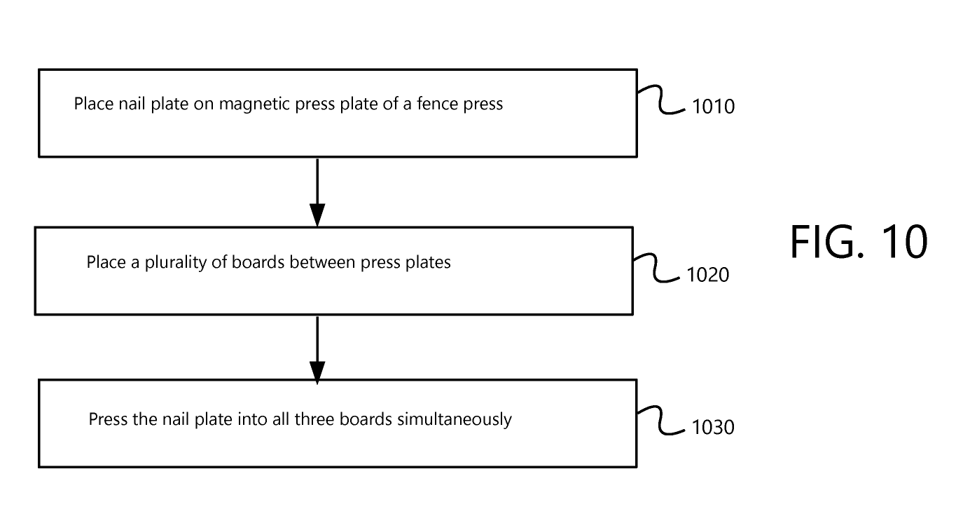

FIG. 10 lists exemplary steps for an alternate method of building a fence gate. In step 1010, the worker may place a nail plate on the contact surface of a magnetic press plate of a fence press, such that the substantially smooth side of the nail plate is magnetically attracted to the contact surface. Similar alignment features as previously discussed may be used with the press plate and/or nail plate. In one embodiment, a second nail plate is similarly placed on the other press plate, which may also contain a magnetic element.

Then, at step 1020, the worker may place a plurality of boards between the press plates, as described herein.

Finally, at step 1030, the worker may press the nail plate (or multiple nail plates) into all three boards simultaneously. This can be done as described with regard to step 930 of FIG. 9.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for creating on-site fence gates, including:
a fence press that includes:
a press frame having a first side, a second side, a top, and a bottom, wherein the first and second sides are opposite from one another and substantially perpendicular to the top and bottom;
a first press plate having a first contact surface; and
a second press plate having a second contact surface that opposes the first contact surface; and
a nail plate that includes a flat side and an opposite side with protrusions, wherein the flat side rests against the first or second press plate such that the opposite side faces the contact surface of the other press plate, and wherein at least one of the protrusions includes a hook element,
wherein the fence press presses the nail plate into a junction of at least three pieces of wood, thereby coupling all three pieces together.

2. The system of claim 1, wherein the hook element includes a sub-protrusion that is punched and bent outward from the protrusion.

3. The system of claim 1, wherein the second contact surface is magnetic, and the nail plate adheres to the second contact surface based on the magnetic force and decouples from the second contact surface once the side with protrusions is imbedded in wood.

4. The system of claim 1, wherein the press frame includes first and second bevel surfaces that join the top of the press frame to the first and second sides respectively, wherein the first bevel surface provides additional stability for the first press plate and the second bevel surface provides additional stability for a support member coupled to a pneumatic element.

5. The system of claim 1, wherein the second press plate is coupled to a pneumatic element that acts as a ram that presses the second press plate towards the first press plate.

6. The system of claim 5, wherein an air hose is coupled to the pneumatic element and an air compressor.

7. A method for creating on-site fence gates, including:
providing a fence press that includes:
a press frame;
a first press plate having a first contact surface; and
a second press plate having a second contact surface that opposes the first contact surface;
placing three boards simultaneously between the first and second press plates;
causing a first nail plate to contact the first or second contact surface, wherein the nail plate includes a flat side and an opposite side with protrusions, wherein the flat side contacts the first or second contact surface; and
pressing the first nail plate into all three boards simultaneously to form a support structure for the fence gate.

8. The method of claim 7, wherein at least some of the protrusions in the first nail plate include a hook element.

9. The method of claim 8, wherein the first nail plate includes an upper-left-most protrusion and a lower-right-most protrusion, each of which include the hook element.

10. The method of claim 9, wherein at least some of the protrusions other than the upper-left-most and lower-right-most protrusions lack the hook element.

11. The method of claim 8, wherein all of the protrusions in the first nail plate include the hook element.

12. The method of claim 7, further including:
determining a ground slope line between first and second gate posts;
positioning a base board against a side support board and a diagonal support board, the vertical and diagonal boards being two of the three boards that are pressed together, the positioning being such that the base board is oriented substantially parallel to the ground slope line when the side support board is substantially vertical;
pressing a second nail plate into the side support board and the base board; and
pressing a third nail plate into the diagonal support board and the base board.

13. The method of claim 12, wherein the second and third nail plates include an upper-left-most protrusion and a lower-right-most protrusion, and the respective upper-left-most and lower-right-most protrusions each include a hook feature.

14. The method of claim 7, wherein placing the first nail plate on the first or second contact surface includes aligning the first nail plate with a magnetic portion of the second contact surface.

15. A nail plate including:
a substantially flat side; and
a protrusion side with a plurality of protrusions extending from the nail plate, wherein the plurality of protrusions include at least two protrusions that include a hook element, the at least two protrusions being at an outer periphery of the plurality of protrusions.

16. The nail plate of claim 15, wherein the nail plate includes a width of less than 5 inches and a height of less than 8 inches.

17. The nail plate of claim 16, wherein the plurality of protrusions includes at least two types of protrusions adjacent to one another and of different lengths and with different hook elements.

18. The nail plate of claim 17, wherein the different hook elements include a sub-protrusion punched out of a first protrusion and a second hook element formed as part of the shape of a second protrusion that is punched from the nail plate.

19. The nail plate of claim 15, wherein the nail plate includes protrusions of at least three different lengths, with less of the longest length protrusion than the shortest length.

20. The nail plate of claim 15, wherein the nail plate includes three separate regions of protrusions that indicate where to align three different boards for joining with the nail plate.
